(19) United States
(12) Patent Application Publication
(10) Pub. No.: US 2020/0307736 A1
(43) Pub. Date: Oct. 1, 2020

(54) Foldable Vehicle

(71) Applicant: Smacircle Technology (Shenzhen) Co., Ltd., Shenzhen (CN)

(72) Inventor: Luyao Zhuang, Shenzhen (CN)

(73) Assignee: Smacircle Technology (Shenzhen) Co., Ltd., Shenzhen (CN)

(21) Appl. No.: 16/305,508

(22) PCT Filed: May 23, 2017
(86) PCT No.: PCT/CN2017/085468

§ 371 Date: Nov. 29, 2018

(30) Foreign Application Priority Data
May 31, 2016 (CN) 201610375620.2
May 31, 2016 (CN) 201620520870.6

(51) Int. Cl. B62K 15/00; B62K 21/22; B62K 21/02; B62K 21/26; B62K 21/12

(52) U.S. Cl. CPC B62K 15/006; B62K 21/22; B62K 21/12; B62K 21/26; B62K 21/02

(57) ABSTRACT

A foldable vehicle comprising a vehicle frame main body. The vehicle frame main body comprises a crossing member that goes through the front end and the back end of the vehicle. The crossing member is provided with a folding mechanism (3) that reduces the length of the foldable vehicle. During the folding process, only the length of the foldable vehicle is reduced, and the height of the foldable vehicle is unchanged, thereby addressing the problem in the prior art that the height of a foldable vehicle substantially increases after folding, thus enabling the folded vehicle to be placed within a regular accommodation space more conveniently, and effectively enhancing the portability of a foldable vehicle.

### BACKGROUND OF THE INVENTION

### 1. Field of the Invention

The present invention relates to the technical field of the production of micro-scooters, and in particular, to a folding bicycle.

### 2. Description of the Prior Art

As living standards improve, people's lives have increasingly diverse needs, so folding bicycles that are suitable for urban short-distance travel and which are easy to carry are becoming more and more the choice of consumers.

In general, a goal of minimal folding is pursued which allows for hand-carrying, or placement in a trunk of a car, of a very light foldable bicycle.

FIG. 1 illustrates an existing folding bicycle, and the main body of the frame is formed by two rod members which are hinged to each other, respectively, a handlebar mounting rod 01 and a seat mounting rod 02, and a hinge point of the two rods is located at their respective midpoints, where they are hinged to form an X shape. The front and rear wheels are respectively positioned on the seat mounting rod 02 and the handlebar mounting rod 01. After folding, since the vehicle is significantly increased in the height direction, the shape of an elongated rod is formed. Although the volume occupied in the width direction is small, it takes up a large space in the longitudinal direction, which is disadvantageous for the placement of the vehicle body in the accommodating space, and is more unfavorable for carrying around.

Thus, how to provide a foldable vehicle that is easy to store and easy to carry around after folding is a technical problem urgently needed to be solved by those skilled in the art.

### SUMMARY OF THE INVENTION

The object of the present invention is to provide a folding vehicle which is easier to store and to carry around, after folding.

In order to achieve the above object, the present invention provides a folding vehicle which includes a frame main body including a crossing member extending through the front and rear ends of the vehicle, and the crossing member is provided with a folding mechanism that only reduces the front and rear dimensions of the folding vehicle.

Preferably, the folding mechanism is a pull-type expansion joint with a locking device.

Preferably, the crossing member includes a front portion and a rear segment that are separately disposed, and the front portion and the rear segment are hinged by a hinge axis that is perpendicular to the ground to form the folding mechanism.

Preferably, a front upper mounting arm extends forwardly from a front end of the crossing member, and a front lower mounting arm extends forwardly and downwardly from the front end of the crossing member, and a rear end of the crossing member extends rearwardly and downwardly into a rear lower mounting arm.

A front fork is rotatably disposed on the front lower mounting arm, a front wheel is disposed on the front fork, and a handlebar assembly passes through the front upper mounting arm and is connected to the front fork. A rear wheel is provided on the rear lower mounting arm.

Preferably, the handlebar assembly includes a handlebar riser coupled to the front fork, and a grip disposed at a top end of the handlebar riser, and the handlebar riser is a telescoping tube with a locking device.

Preferably, the outer end of the grip may be bent towards the inside of the folding vehicle, and after folding, the grip forms a handle for the user to lift the folding vehicle.

Preferably, the front wheel is foldably disposed on the front fork and/or the rear wheel is foldably disposed on the rear lower mounting arm.

Preferably, a rear upper mounting arm is further extended rearwardly from the rear end of the crossing member, with a seat disposed on the rear upper mounting arm.

Preferably, the front portion of the crossing member and the front upper mounting arm and the front lower mounting arm form a Y-shaped member, and the rear segment of the crossing member and the rear upper mounting arm and the rear lower mounting arm also form a Y-shaped member.

Preferably, the folding mechanism is located at a midpoint of the crossing member, and after folding, the front upper mounting arm and the rear upper mounting arm, and the front lower mounting arm and the rear lower mounting arm, are respectively attached to each other.

As can be seen from the above technical solution, the folding vehicle disclosed in the present invention includes a frame body, and the frame body includes a crossing member extending through the front and rear ends of the vehicle, and the crossing member is provided with a folding mechanism that only reduces the front and rear dimensions of the folding vehicle.

Since the folding mechanism is disposed on the crossing member and only reduces the front and rear dimensions of the folding vehicle during the folding process, the size of the folding vehicle in the height direction will not change, which overcomes the defect in the prior art that the height of the folding vehicle is significantly increased after folding. Therefore, the folded vehicle is more easily placed in a regular accommodation space, thereby effectively improving the portability of the folding vehicle.

### BRIEF DESCRIPTION OF THE DRAWINGS

FIG. 1 is a schematic structural diagram of a prior art folding vehicle;

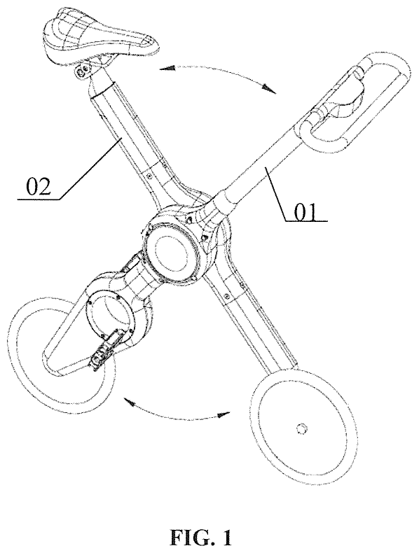

FIG. 2 is a schematic view of one embodiment of a folding vehicle according to the present invention;

FIG. 3 is a schematic view of the folding vehicle in FIG. 2 after folding

Wherein 1 is a front portion, 2 is a rear segment, 3 is a folding mechanism, 4 is a front wheel frame, 5 is a front wheel, 6 is a rear wheel frame, 7 is a rear wheel, 8 is a handle riser, 9 is a grip, and 10 is a vehicle seat.

### DETAILED DESCRIPTION OF THE PREFERRED EMBODIMENTS

The objective of the present invention is to provide a folding vehicle which, after folding, can be easily stored and is easy to carry.

In order to provide those skilled in the art with a better understanding of the invention, the present invention will be described in further detail in conjunction with the accompanying drawings and specific embodiments.

The folding vehicle disclosed in the present invention includes, but is not limited to, electric cars, bicycles, scooters and the like, and the vehicle includes a folding frame body, the frame body including a crossing member passing through the front and rear ends of the vehicle, and there is provided only on the crossing member a folding mechanism 3 for folding the frame body and reducing the front and rear dimensions.

It will be appreciated that the longitudinal folding mechanism 3 can be used to reduce the front and rear size of the vehicle, and it is also possible for the vehicle to recover its original size through reverse folding. Since the folding mechanism 3 is disposed on the crossing member, and the folding process only reduces the longitudinal dimension of the frame body, the height dimension does not change, which overcomes the drawback of increased height experienced by existing folding vehicles, thereby making it easier to store the folding vehicle in a receiving space, and improving the portability of the folding vehicle.

Those skilled in the art will understand that the implementation form of the folding mechanism 3 is not limited to one type. For example, in the embodiment described above, folding mechanism 3 is a pull-out telescopic section having a locking device provided on the crossing member, with a telescopic section allowing the frame body to be shortened and lengthened, thereby allowing for the longitudinal dimension of the frame body to be adjusted. The pull-out telescopic section comprises at least three different sections, with each section being retractable into an adjacent larger section, thereby shortening the overall length of the folding mechanism; and the locking mechanism can be used for the folding mechanism, with the locking mechanism selected from one known in the art such as a positioning pin, or bolts or the like. Still further, it is possible to provide two segments adjacent to each other that can be connected by rollers, bearings or sliders for smooth operation. After the retraction is in the desired location, a locking device locks the pull-out extension to prevent movement or loosening of the extension.

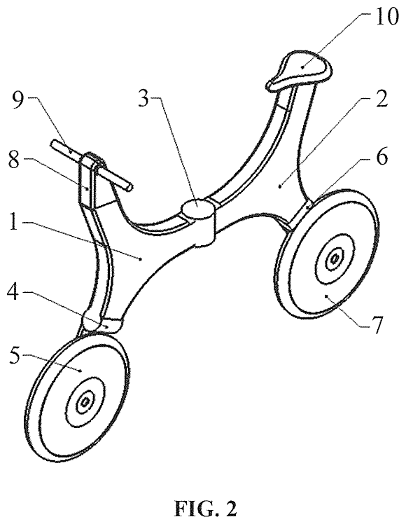

In another embodiment of the present invention, the crossing member includes a front portion 1 and a rear segment 2 that are provided separately, and the front portion 1 and rear segment 2 are hinged by a hinge axis that is perpendicular to the ground, with the hinge position of the front portion 1 and the rear segment 2 constituting the folding mechanism 3. Of course, the fact that the folding mechanism 3 has a locking device should ensure that the structure of the folding vehicle can be maintained stable in both the driving state and the folded state, as shown in FIG. 2.

Referring to FIG. 2, a front upper mounting arm extends forwardly from a front end of the crossing member, and a front lower mounting arm extends forwardly and downwardly. The rear lower mounting arm is extended rearwardly and downwardly from the rear end of the crossing member A front fork is rotatably disposed on the front lower mounting arm. A front wheel 5 is disposed on the front fork. A handlebar assembly is inserted from the top end of the front upper mounting arm and connected to the front fork, so that the front wheel 5 can be turned by the front fork. At the lower end of the rear segment, a rear wheel 7 is provided on the mounting arm.

In addition, considering the portable nature of the folding vehicle, the handlebar assembly includes a handlebar riser 8 coupled to the front fork and a grip 9 disposed at the top end of the handlebar riser 8, with the handlebar riser 8 configured as an extension tube with a locking device. Similarly, the locking device can also be provided in the form of a positioning pin, a top bolt, a screw or a quick release wrench. When the vehicle needs to be folded, the locking device is unlocked, and then the extension tube is contracted, thereby further reducing the space occupied by the folding vehicle.

In the present embodiment, the outer end of the grip 9 can be bent towards the inner side of the folding vehicle, the grip 9 and the handlebar riser 8 are connected by a folding mechanism, and after the entire vehicle is folded, the grip 9 forms a handle for the user to lift the folding vehicle, which further enhances the portability of the folding vehicle. Preferably, one of the front wheel 5 and the rear wheel 7, or both, are foldably disposed on the front fork or the rear lower mounting arm, which can be such that the front wheel 5 and/or the rear wheel 7 are folded to the position of the frame body after the entire vehicle is folded to reduce the volume of the folding vehicle. The front wheel 5 can be foldably connected to the front fork through the front wheel frame 4, and the rear wheel 7 can be foldably connected to the rear lower mounting arm through the rear wheel frame 6. Of course, in order to prevent the front wheel 5 and the rear wheel 7 from loosening, a locking device should also be provided, and the locking device should play a locking role when the wheel is opened and stored.

Considering the comfort of the rider, the folding vehicle disclosed in the embodiment has a rear upper mounting arm extending rearwardly from the rear end of the crossing member, and a seat 10 is further disposed on the rear upper mounting arm, as shown in FIG. 2. The seat 10 is preferably connected to the rear upper mounting arm via a seat riser and the seat riser is a retractable tube with a locking device.

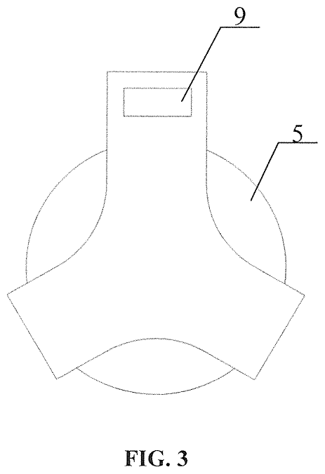

As shown in FIGS. 2 and 3, in the present embodiment, the front portion of the crossing member and the front upper mounting arm and the front lower mounting arm form a Y-shaped member, the rear segment of the crossing member and the rear upper mounting arm and the rear lower mounting arm also form a Y-shaped member, which not only reduces the space occupied by the folded vehicle, but also enhances the aesthetics of the folded body.

In addition, the folding mechanism is located at the midpoint of the crossing member beam, and after folding, the front upper mounting arm and the rear upper mounting arms are attached to each other; and the front lower mounting arm and the rear lower mounting arm are attached to each other. The lengths of these mounting arms are set to be approximately the same, and the whole vehicle will be folded to provide a three-pronged pattern. The front and rear wheels are dotted in the middle of the trigeminal pattern, which further reduces the space occupied by the folding vehicle and is aesthetically more modern as shown in FIG. 3.

The entire vehicle can be made of aluminum alloy, aluminum-bismuth alloy, steel, or carbon fiber. When a small part of the structure uses carbon fiber and most of the structure is made of aluminum alloy, if the folding vehicle disclosed in the present invention is made into an electric vehicle, when its maximum endurance is about 20 kilometers, the overall weight can be controlled at about 6 kg, and its folded volume can be controlled at 300*120*350 mm (length*width*height), which is extremely light, minimal and beautiful.

The folding vehicle of the present invention has been described in detail above. The embodiments of the present invention have been described by way of specific examples, and the description of the above embodiments is only for facilitating understanding of the method of the present invention and its basic principles. It is to be understood that the present invention may be modified by those skilled in the art without departing from the scope of the invention. Such modifications are also intended to fall within the scope of the appended claims of the present invention.

What is claimed is:

1. A folding vehicle comprising a main body of the frame, wherein the main body of the frame comprises a crossing member passing through front and rear ends of the vehicle, and the crossing member is provided with a folding mechanism (3) which reduces the front and rear dimensions of the folding vehicle.

2. The folding vehicle of claim 1, wherein the crossing member comprises a front portion (1) and a rear segment (2) provided separately, and the front portion (1) and the rear segment (2) are hinged by a hinge shaft that is perpendicular to the ground to form the folding mechanism (3).

3. The folding vehicle of claim 2, wherein a front upper mounting arm extends forwardly from a front end of the crossing member, and a front lower mounting arm extends forward and downward; and a rear lower mounting arm extends rearward and downward from a rear end of the crossing member; wherein a front fork is rotatably disposed on the front lower mounting arm, and a front wheel (5) is disposed on the front fork; and a handlebar assembly passes through the front upper mounting arm and is coupled to the front fork, and a rear wheel (7) is provided on the rear lower mounting arm.

4. The folding vehicle of claim 3, wherein the handlebar assembly includes a handlebar riser (8) coupled to the front fork, and a grip (9) disposed at a top end of the handlebar riser (8), and wherein the riser (8) is a telescopic tube with a locking device.

5. The folding vehicle of claim 3, wherein an outer end of the grip (9) is bent towards an inner side of the folding vehicle, and after folding, the grip (9) is formed by the user to lift the handle of the folding vehicle.

6. The folding vehicle of claim 3, wherein the front wheel (5) is foldably disposed on the front fork and/or the rear wheel (7) is foldably disposed on the rear lower mounting arm.

7. The folding vehicle of claim 3, wherein the rear end of the crossing member is further extended with a rear upper mounting arm, and the rear upper mounting arm is further provided with a seat (10).

8. The folding vehicle of claim 7, wherein the front portion (1) of the crossing member and the front upper mounting arm and the front lower mounting arm form a Y-shaped member, and the rear segment (2) of the crossing member and the rear upper mounting arm and the rear lower mounting arm also form a Y-shaped member.

9. The folding vehicle of claim 8, wherein the folding mechanism is located at a midpoint of the crossing member, and after folding, the front upper mounting arm and the rear upper mounting arm, and the front lower mounting arm and the rear lower mounting arm, are respectively attached to each other.

10. The folding vehicle of claim 1, wherein the folding mechanism (3) is a pull-type telescopic joint with a locking device.
